(19) United States
(12) Patent Application Publication
(10) Pub. No.: US 2025/0321780 A1
(43) Pub. Date: Oct. 16, 2025

(54) OPTIMIZING GRAPHICS PROCESSING UNITS (GPUs) EFFICIENCY WITHIN A GPU BANK VIA IDLE PERIOD USAGE

(71) Applicant: BANK OF AMERICA CORPORATION, Charlotte, NC (US)

(72) Inventors: Maharaj Mukherjee, Poughkeepsie, NY (US); Carl M. Benda, Kannapolis, NC (US)

(73) Assignee: BANK OF AMERICA CORPORATION, Charlotte, NC (US)

(21) Appl. No.: 18/635,491

(22) Filed: Apr. 15, 2024

(51) Int. Cl. G06F 9/48; G06T 1/20

(52) U.S. Cl. CPC G06F 9/485; G06T 1/20

(57) ABSTRACT

Graphics Processing Unit (GPU) efficiency is optimized within a GPU bank via idle/wait period usage. Data flow graph(s) are created for jobs/software programs executing on a GPU bank and the data flow graph(s) are utilized as the basis for estimating idle/waits periods that will be incurred by a GPU. In response to estimating the idle/wait period, a thread is identified that will be ready for execution proximate the estimated start time of the idle period and the identified thread is executed on the GPU proximate the actual start time of the idle period. Additionally, results of intermediate computations stored within the registers of the GPU may be temporarily moved to secondary storage, such as cache, dedicated registers or the like to facilitate the use of the registers for executing the identified thread during the idle/wait period.

### FIELD OF THE INVENTION

The present invention is generally directed to optimizing Graphics Processing Unit (GPU) efficiency and, more specifically, generating data flow graphs for jobs/software programs executing on a GPU bank and utilizing the data flow graphs as the basis for estimating idle/wait periods that will be incurred by a GPU. In response to estimating the idle/wait period, a thread is identified that will be ready for execution proximate the estimated start time of the idle/wait period and the identified thread is executed on the GPU proximate the actual start time of the idle/wait period.

### BACKGROUND

Artificial Intelligence (AI) models, such as Generative AI (Gen-AI) models, Large Learning Models (LLMs) and the like, deep learning and High-Performance Computing (HPC) are highly processing-intensive operations and, as such, require the use of extensive Graphics Processing Unit (GPU) banks comprising a massive volume of GPUs, which allow for parallel processing of tasks associated with such processing-intensive operations. Without the enormous parallelization offered by GPUs in a GPU bank it is also impossible to create the foundational models required of Gen-AI models, LLMs and the like that may incorporate millions of types of different features.

In this regard, many operations undertaken by the GPUs of a GPU bank perform parallel matrix multiplication, which all tasks in each GPU to be performed independent of one another. However, certain operations can not be performed in parallel and must be performed serially. For example, certain computations are dependent on the results of other intermediary computations, which must be completed before the final computations can be performed/calculated. In such instances, the GPU awaiting the results of other intermediary computations undergoes a locking mechanism and incurs an idle period/time, otherwise referred to as a wait period/time, during the GPU in non-operational. Such idle periods/wait times result in inefficient use of the GPUs.

Moreover, entities continue create larger and larger foundational models, which inherently require more GPUs and thus increase the demand, which, of late, has greatly exceeded supply. As such, efficiency of existing GPUs becomes even more critical.

Therefore, a need exists to develop systems, methods, computer program products and the like that overcome inefficiencies in GPU usage within GPU banks. Specifically, desired systems, methods, computer program products should address inefficiencies resulting from GPUs being “locked” and experiencing an idle period or wait time as they await the results of intermediary calculations performed on other GPUs.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for optimization of the use of GPUs within a GPU bank. Specifically, the present invention provide for a novel means by which the idle period (i.e., wait time) incurred by GPU can be utilized. Specifically, the present invention relies on data flow graphs, which are created for jobs/software programs executing on a GPU bank. Subsequently, data flow graphs are utilized as the basis for estimating idle/waits periods that will be incurred by a GPU. In response to estimating the idle/wait period, a thread is identified that will be ready for execution proximate the estimated start time of the idle period and the identified thread is executed on the GPU proximate the actual start time of the idle period.

Additionally, in specific embodiments of the invention, results of intermediate computations stored within the registers of the GPU that incurs the idle period are temporarily moved to secondary memory, such as cache, dedicated registers or the like to facilitate the use of the registers for executing the identified thread during the idle/wait period. Once the identified thread has been executed on the GPU and the final computation is ready for execution, the results of the intermediary computation are retrieved from the secondary memory.

In specific embodiments of the invention, once the data flow graph(s) are created they are converted to time-scale, so that the idle periods/waits periods can be estimated. Such estimations rely not only on the data flow graph(s) but also other factors such as, but not limited to, (i) a volume of the plurality of GPUs, (ii) a type (specifically, speed) of each of the plurality of GPUs, (iii) a clock cycle for each of the plurality of GPUs and (iv) other job(s) entering and exiting the data flow graph at a point-in-time.

In specific embodiments of the invention, estimating the idle period includes estimating both the start time and the end time of the idle period. In such embodiments of the invention, identification of a thread that will be ready for execution proximate the estimated start time additionally includes identifying a thread having an estimated execution time that meets the boundaries defined by the start time and the end time of the idle period (i.e., ensuring that the identified thread “fits” within the allotted time of the idle period).

In other specific embodiments of the invention, estimating the idle period is limited to estimating the start time of the idle period. In such embodiments of the invention, the end time of the idle period may not be determinative in identifying the thread that is to be executed on the GPU during the idle period. In such embodiments of the invention, it may be necessary to identify another GPU for executing the task that the GPU was waiting on (i.e., the task that resulted in the idle period), if all intermediate tasks/calculations have been executed and the GPU is still executing the identified thread. In other words, it may be necessary and the invention provides for moving the final task/calculation to another GPU.

A system for optimizing Graphics Processing Unit (GPU) usage defines first embodiments of the invention. The system includes a GPU bank, which includes a plurality of GPUs and is configured to execute a plurality of processes of one or more jobs in parallel. The system additionally includes a computing platform having a memory, and one or more computing processor devices in communication with the memory. The memory stores a GPU optimization platform that is executable by at least one of the one or more computing processor devices. The GPU optimization platform is configured to generate a data flow graph(s) for a software program associated with a job from amongst the one or more jobs. While the software program is executing on the GPU bank, the GPU optimization platform is further configured to (i) convert the data flow graph(s) to time-scale and based at least on the converted data flow graph(s), (ii) estimate a start time of an idle period that will be incurred by a first GPU from amongst the plurality of GPUs in the GPU bank. Moreover, the GPU optimization platform is further configured to identify a first thread from a process from amongst the plurality of processes that will be ready for execution at the estimated start time of the idle period and execute the identified first thread on the first GPU proximate to an actual start time of the idle period.

In specific embodiments of the system, the GPU optimization platform is further configured to, in response to identifying the first thread and prior to executing the first thread on the first GPU, transfer results of intermediate computations from one or more registers of the first GPU to a secondary memory. In this regard, the results of intermediate computations (i.e., the basis for the idle period) are offloaded to a secondary memory, while another thread utilizes the computational registers of the GPU and the results of the intermediate computations are subsequently retrieved from the secondary memory when other intermediate computations performed on other GPUs are ready for final computation. In specific embodiments of the system, the secondary memory may comprise one of (i) a cache of the first GPU, (ii) one or more storage registers within the first GPU dedicated for storage of the results of intermediate computations, and (iii) cloud storage.

In other specific embodiments of the system, the GPU optimization platform is further configured to (i) convert the data flow graph(s) to time-scale and (ii) estimate the start time of the idle period that will be incurred by the first GPU based on one or more of (i) a volume of the plurality of GPUs, (ii) a speed of each of the plurality of GPUs, (iii) a clock cycle for each of the plurality of GPUs and (iv) other job(s) entering and exiting the data flow graph(s) at a point-in-time.

In further specific embodiments of the system, the GPU optimization platform is further configured to identify a second GPU from amongst the plurality of GPUs to execute a second thread which was awaiting execution on the first thread after conclusion of the idle period and execute the second thread on the second GPU while the first thread is executing on the first GPU. In such embodiments of the invention, execution of the second thread on the second GPU and, in some instances identification of the second GPU may only occur after the idle period has expired (e.g., all intermediate calculations have occurred) and the first thread is still executing on the first GPU.

In still further embodiments of the system, the GPU optimization platform is further configured to, based at least on the converted data flow graph(s), estimate an end time of the idle period that will be incurred by the first GPU. In related embodiments of the system, the GPU optimization platform is further configured to identify the first thread from the process based further on an estimated execution time of the first thread being within boundaries of the start time and end time of the idle period (i.e., the first thread fitting within the start and end time of the idle period).

Moreover, in additional specific embodiments of the system, the GPU optimization platform is further configured to identify the first thread from the process, wherein the process is selected from the group consisting of (i) associated with the job undertaken by the software program, and (ii) associated with another job undertaken by a different software program. In other words, the thread that is chosen for execution during the GPU's idle period may a thread from a process associated with the software program/data flow graph(s) or a thread from another process associated with a different job/software program executing on the GPU bank.

A computer-implemented method for optimizing GPU usage defines second embodiments of the invention. The computer-implemented method is executable by one or more computing processor devices. The method includes generating data flow graph(s) for a software program associated with a job from amongst the one or more jobs executable by a GPU bank that includes a plurality of GPUs. While the software program is executing on the GPU bank, the method further includes (i) converting the data flow graph(s) to time-scale and, based at least on the converted data flow graph(s), (ii) estimating a start time of an idle period that will be incurred by a first GPU from amongst the plurality of GPUs in the GPU bank. In response to estimating the start time of the idle period the first GPU, the method includes identifying a first thread from a process from amongst the plurality of processes that will be ready for execution at the estimated start time of the idle period and executing the first thread on the first GPU proximate to an actual start time of the idle period.

In specific embodiments the computer-implemented method further includes, in response to identifying the first thread and prior to executing the first thread on the first GPU, transferring results of intermediate computations from one or more registers of the first GPU to a secondary memory. In specific related embodiments of the computer-implemented method, the secondary memory includes one of (i) a cache of the first GPU, (ii) one or more storage registers within the first GPU dedicated for storage of the results of intermediate computations, and (iii) cloud storage.

In further specific embodiments of the computer-implemented method, converting and estimating further comprise (i) converting the data flow graph(s) to time-scale and (ii) estimating the start time of the idle period that will be incurred by the first GPU based further on one or more of (i) a volume of the plurality of GPUs, (ii) a speed of each of the plurality of GPUs, (iii) a clock cycle for each of the plurality of GPUs, and (iv) jobs entering and exiting the data flow graph(s) at a point-in-time.

In still further specific embodiments, the computer-implemented method includes identifying a second GPU from amongst the plurality of GPUs to execute a second thread which was awaiting execution on the first thread after conclusion of the idle period and executing the second thread on the second GPU while the first thread is executing on the first GPU.

Moreover, in additional specific embodiments the computer-implemented method includes, based at least on the converted data flow graph(s), estimating an end time of the idle period that will be incurred by the first GPU. In such embodiments of the computer-implemented method, identifying the first thread further includes identify the first thread from the process based further on an estimated execution time of the first thread being within boundaries of the start time and end time of the idle period.

A computer program product including a non-transitory computer-readable medium defines third embodiments of the invention. The non-transitory computer-readable medium includes a first set of codes for causing a computing device to generate data flow graph(s) for a software program associated with a job from amongst the one or more jobs executable by GPU bank comprising a plurality of GPUs. Further, the computer-readable medium includes a second set of codes for causing a computing device to, while the software program is executing on the GPU bank, (i) convert the data flow graph to time-scale and, based at least on the converted data flow graph, (ii) estimate a start time of an idle period that will be incurred by a first GPU from amongst the plurality of GPUs in the GPU bank. In addition, the computer-readable medium includes a third set of codes for causing a computing device to identify a first thread from a process from amongst the plurality of processes that will be ready for execution at the estimated start time of the idle period. Moreover, the computer-readable medium includes a fourth set of codes for causing a computing device to execute the first thread on the first GPU proximate to an actual start time of the idle period web browsing session data.

In specific embodiments of the computer program product, the computer-readable medium includes a fifth set of codes for causing a computer device to, in response to identifying the first thread and prior to executing the first thread on the first GPU, transfer results of intermediate computations from one or more registers of the first GPU to a secondary memory. In related embodiments of the computer program product, the secondary memory may comprise one of (i) a cache of the first GPU, (ii) one or more storage registers within the first GPU dedicated for storage of the results of intermediate computations, and (iii) cloud storage.

In other specific embodiments of the computer program product, the second set of codes are further configured to cause the computing device to (i) convert the data flow graph(s) to time-scale and (ii) estimate the start time of the idle period that will be incurred by the first GPU based further on one or more of (i) a volume of the plurality of GPUs, (ii) a speed of each of the plurality of GPUs, (iii) a clock cycle for each of the plurality of GPUs, and (iv) jobs entering and exiting the data flow graph(s) at a point-in-time.

In additional specific embodiments of the computer program product, the computer-readable medium further includes a fifth set of codes for causing a computing device to identify a second GPU from amongst the plurality of GPUs to execute a second thread which was awaiting execution on the first thread after conclusion of the idle period and a sixth set of codes for causing a computing device to execute the second thread on the second GPU while the first thread is executing on the first GPU.

Moreover, in additional specific embodiments of the computer program product, the second set of codes are further configured to cause the computing device to, based at least on the converted data flow graph(s), estimate an end time of the idle period that will be incurred by the first GPU. In such embodiments of the computer program product, the third set of codes are further configured to cause the computing device to identify the first thread from the process based further on an estimated execution time of the first thread being within boundaries of the start time and end time of the idle period.

Thus, according to embodiments of the invention, which will be discussed in greater detail below, the present invention addresses needs and/or achieves other advantages by optimizing Graphics Processing Unit (GPU) efficiency within a GPU bank via idle/wait period usage. Specifically, data flow graphs are created for jobs/software programs executing on a GPU bank and the data flow graphs are utilized as the basis for estimating idle/waits periods that will be incurred by a GPU. In response to estimating the idle/wait period, a thread is identified that will be ready for execution proximate the estimated start time of the idle period and the identified thread is executed on the GPU proximate the actual start time of the idle period. Additionally, results of intermediate computations stored within the registers of the GPU may be temporarily moved to secondary storage, such as cache, dedicated registers or the like to facilitate the use of the registers for executing the identified thread during the idle/wait period.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for optimization of GPU usage in a GPU bank, in accordance with embodiments of the present invention;

FIG. 2 is a block diagram of a computing platform including a GPU optimization platform, in accordance with alternate embodiments of the present invention;

FIG. 3 is a schematic graph representing usage of GPUs in a GPU bank, in accordance with the prior art;

FIG. 4 is a schematic graph of representing usage of an idle period in a GPU of a GPU bank, in accordance with embodiments of the invention;

FIG. 5A is a schematic graph representing usage of an idle period in a GPU of a GPU bank in which execution of the identified thread has exceeded the time at which GPU is ready to execute the thread that prompted the idle period, in accordance with embodiments of the present invention;

FIG. 5B is a schematic graph representing usage of another GPU of a GPU bank to execute the thread that prompted the idle period on the GPU, in accordance with embodiments of the present invention; and

FIG. 6 is a flow diagram of a method for optimization of the usage of a GPU in a GPU bank, in accordance with alternate embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, a.), or an embodiment combining software and hardware aspects that may be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform may include a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that provide for optimization of the use of GPUs within a GPU bank. Specifically, the present invention provides novels means by which the idle periods (i.e., wait times) incurred by GPU during conventional processing can be utilized. Specifically, the present invention relies on data flow graphs, which are created for jobs/software programs executing on a GPU bank. Subsequently, data flow graphs are utilized as the basis for estimating idle/waits periods that will be incurred by a GPU. In response to estimating the idle/wait period, a thread is identified that will be ready for execution proximate the estimated start time of the idle period and the identified thread is executed on the GPU proximate the actual start time of the idle period.

Additionally, in specific embodiments of the invention, results of intermediate computations stored within the registers of the GPU that incurs the idle period are temporarily moved to secondary memory, such as cache, dedicated registers or the like to facilitate the use of the registers for executing the identified thread during the idle/wait period. Once the identified thread has been executed on the GPU and the final computation is ready for execution, the results of the intermediary computation are retrieved from the secondary memory.

In specific embodiments of the invention, once the data flow graph(s) are created they are converted to time-scale, so that the idle periods/waits periods can be estimated. Such estimations rely not only on the data flow graph(s) but also other factors such as, but not limited to, (i) a volume of the plurality of GPUs, (ii) a type (specifically, speed) of each of the plurality of GPUs, (iii) a clock cycle for each of the plurality of GPUs and (iv) other job(s) entering and exiting the data flow graph(s) at a point-in-time.

In specific embodiments of the invention, estimating the idle period includes estimating both the start time and the end time of the idle period. In such embodiments of the invention, identification of a thread that will be ready for execution proximate the estimated start time additionally includes identifying a thread having an estimated execution time that meets the boundaries defined by the start time and the end time of the idle period (i.e., ensuring that the identified thread “fits” within the allotted time of the idle period).

In other specific embodiments of the invention, estimating the idle period is limited to estimating the start time of the idle period. In such embodiments of the invention, the end time of the idle period may not be determinative in identifying the thread that is to be executed on the GPU during the idle period. In such embodiments of the invention, it may be necessary to identify another GPU for executing the task that the GPU was waiting on (i.e., the task that resulted in the idle period), if all intermediate tasks/calculations have been executed and the GPU is still executing the identified thread. In other words, it may be necessary and the invention provides for moving the final task/calculation to another GPU.

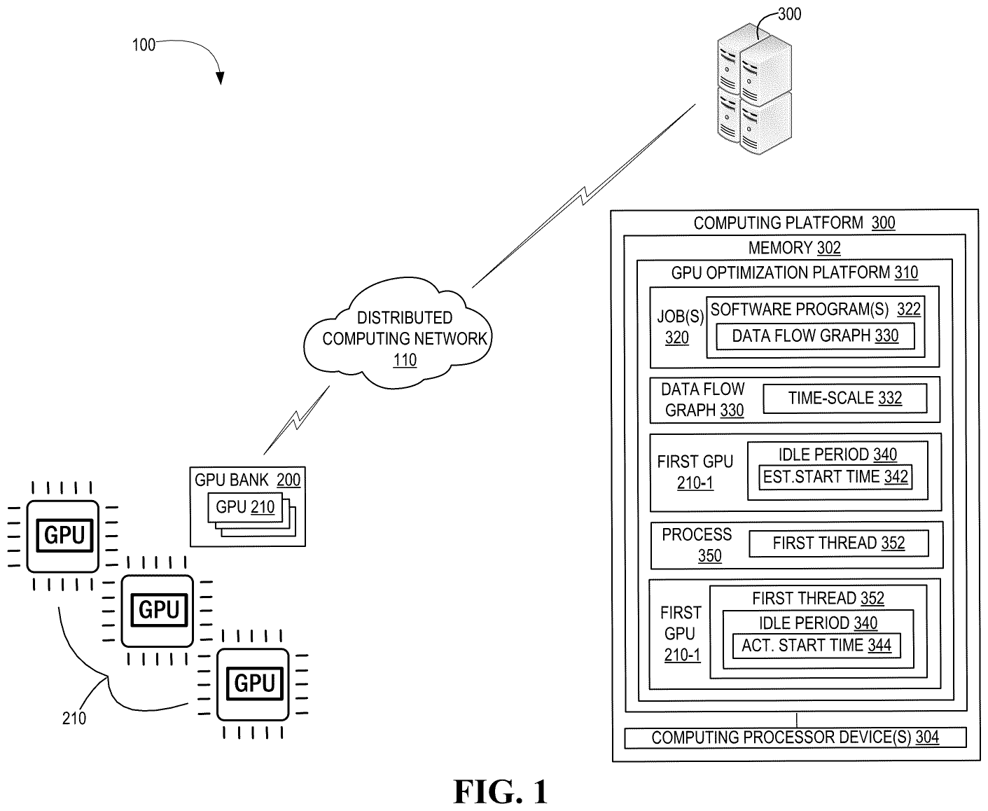

Referring to FIG. 1, a schematic/block diagram is presented of an exemplary system 100 for optimizing GPU usage within a GPU bank, in accordance with embodiments of the present invention. The system 100 is implemented across a distributed communication network 110, such as an intranet or the like. As depicted, the system 100 includes a GPU bank 200, also commonly referred to as a GPU cluster or GPU farm, including a plurality of GPUs 210. The number of GPUs 210 in the GPU bank 200 may vary from a few dozen to thousands depending upon intended use.

System 100 additionally includes a computing platform 300, which may comprise one or more servers or the like. The computing platform 300 includes a memory 302 and one or more computing processor devices 304 in communication with memory 302. Memory 302 stores GPU optimization platform 310 that is executable by at least one of the one or more computing processor devices 304.

GPU optimization platform 310 is configured to generate data flow graph(s) 330 for one or more software programs 322 associated with one or more jobs 320 executing on the GPUs 210 of the GPU bank 200. A data flow graph 330, otherwise referred to as a computational graph, as used herein is a graphical representation of a computational process, illustrating the order in which the processes occur. In a data flow graph, nodes represent processes, while edges represent the flow of data between the operations. Each node typically performs a specific mathematical operation, such as addition, multiplication, or matrix manipulation. The data flowing between the nodes are usually multi-dimensional arrays, know an tensors, which carry the input data, intermediate results and output data of the computation. In this regard, data flow graphs express the dependencies between operations, enable parallel execution of independent computations, and provide a structed way to represent and execute complex computations in data-intensive tasks/jobs.

In response to generating the data flow graph(s) 330 and while the software program(s) 322 are executing on the GPU bank 200, the GPU optimization platform 310 is further configured to (i) convert the data flow graph(s) 330 to time scale 332 and, based on the converted data flow graph(s) (ii) estimate a start time 342 for an idle period 340 (also commonly referred to as a wait period, i.e., not actively processing any tasks or computations) that will be incurred by a first GPU 210-1 from amongst the plurality of GPUs 210 in the GPU bank 200.

In response to estimating the start time 342 of the idle period 340, the GPU optimization platform 310 is further configured to identify a first thread 352 from a process 350 executing on the GPUs 210 that will be ready for execution at the estimated start time 342 of the idle period 340. In response to identifying the first thread 352, the GPU optimization platform is further configured to execute the first thread 352 on the first GPU proximate to the actual start time 344 of the idle period 340.

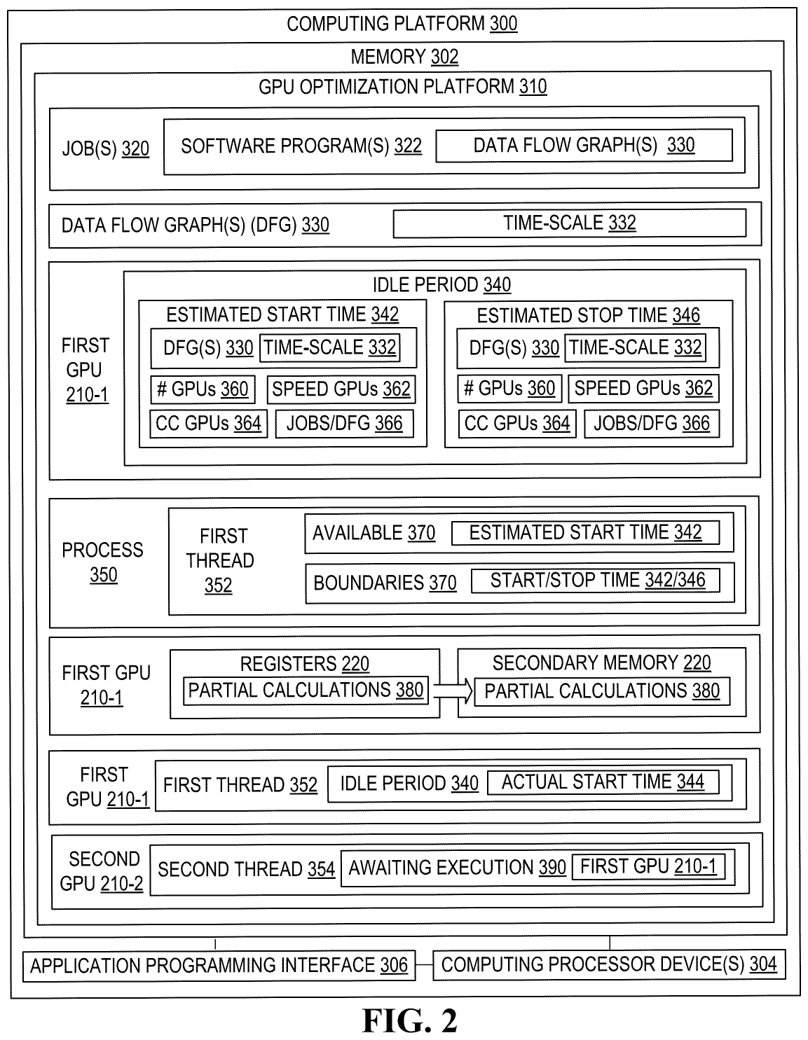

Referring to FIG. 2, a block diagram is depicted of computing platform 300 including GPU optimization platform 310, in accordance with embodiments of the present invention. In addition to providing greater detail, FIG. 2 highlights various alternate embodiments of the GPU optimization platform 310. Computing platform 400 comprises one or more computing devices, such as servers or the like, configured to execute software programs, including sub-systems, instructions, engines, algorithms, modules, routines, applications, tools, and the like. As previously discussed, GPU optimization platform 310 includes memory 302, which may comprise volatile and non-volatile memory, such as read-only memory (ROM) and/or random-access memory (RAM), EPROM, EEPROM, flash cards, or any memory common to computer platforms. Moreover, memory 302 may comprise cloud storage, such as provided by a cloud storage service and/or a cloud connection service.

Further, computing platform 300 also includes computing processor device(s) 304, which may be an application-specific integrated circuit (“ASIC”), or other chipset, logic circuit, or other data processor device. Computing processor device 304 may execute an application programming interface (“API”) 306 that interfaces with any resident programs, such as GPU optimization platform 310 and algorithms, sub-engines/routines associated therewith or the like stored in the memory 302 of the computing platform 300.

Computing processor device(s) 304 may include various processing subsystems (not shown in FIG. 2) embodied in hardware, firmware, software, and combinations thereof, that enable the functionality of computing platform 300 and the operability of computing platform 400 on a distributed communication network 110 (shown in FIG. 1). For example, processing subsystems allow for initiating and maintaining communications and exchanging data with other networked devices, such as the GPU bank 200 (shown in FIG. 1). For the disclosed embodiments of the invention, processing subsystems of computing processor device 304 may include any subsystem used in conjunction with GPU optimization platform 310 and related engines, routines, algorithms, sub-algorithms, modules, sub-modules thereof.

Computing platform 300 additionally includes a communications module (not shown in FIG. 2) embodied in hardware, firmware, software, and combinations thereof, that enables electronic communications between computing platform 300 and other networks and/or networked devices. Thus, the communication module may include the requisite hardware, firmware, software and/or combinations thereof for establishing and maintaining a network communication connection with one or more systems, platforms, networks, or the like.

As previously discussed in relation to FIG. 1, memory 302 of computing platform 400 stores GPU optimization platform 310 that is executable by the computing processor device(s) 304. GPU optimization platform 310 is configured to GPU optimization platform 310 is configured to generate one or more data flow graphs 330 for one or more software programs 322 associated with one or more jobs 320 executing on the GPUs 210 of the GPU bank 200. In response to generating the data flow graph(s) 330 and while the software program(s) 322 are executing on the GPU bank 200, the GPU optimization platform 310 is further configured to (i) convert the data flow graph(s) 330 to time-scale 332 and, based on the converted data flow graph(s) (ii) estimate a start time 342 for an idle period 340 (also commonly referred to as a wait period, i.e., not actively processing any tasks or computations) that will be incurred by a first GPU 210-1 from amongst the plurality of GPUs 210 in the GPU bank 200, and, in specific embodiments, (iii) estimate the stop/end time 346 for the idle period 340. In specific embodiments of the system 100, the GPU optimization platform 310 is further configured to estimate the start time 342 and the spot time 346 based further on other factors in the GPU bank 200, such as but not limited to, number 360 of GPUs 210 in the GPU bank 200, speed 362 of each GPU 210 in the GPU bank, clock cycle 364 of each GPU 210 in the GPU bank and dynamic factors, such as, but not limited to, the jobs 366 entering or exiting the data flow graph(s) 330 at any point in time.

In response to estimating the start time 342 of the idle period 340, the GPU optimization platform 310 is further configured to identify a first thread 352 from a process 350 executing on the GPUs 210 that will be available 370 for execution at the estimated start time 342 of the idle period 340. In other embodiments of the system 100, in which the GPU optimization platform 310 estimates the stop time 346 of the idle period 340, the GPU optimization platform 310 is further configured to identify the first thread 352 based on estimated execution time of the first thread 352 being within the boundaries 370 of the estimated start time 342 and stop time 346 (i.e., the first thread 352 “fits” in the time period of the idle period 340). It should be noted that in specific embodiments of the system 100, time buffers may be taken into consideration to ensure that the estimated execution time of the first thread 352 is within the boundaries 370 of the estimated start time 342 and stop time 346.

In specific embodiments of the system 100, in response to identifying the first thread 352 and prior to executing the first thread 352 on the first GPU 210-1, GPU optimization platform 310 is configured to transfer results of partial/intermediate calculations 380 from one or more registers 220 of the first GPU 210-1 to secondary memory 220, which may internal or external to first GPU-1. The transfer of the results of partial/intermediate calculations 380 frees up the registers 220 in order to execute first thread 352 of the first GPU 210-1. Once the first thread 352 has completed processing, the partial/intermediate calculations 380 will transferred back from the secondary memory 220 to one or more registers 220 of the first GPU 210-1 (or if the first thread 352 is still executing at the first GPU 210-1 at the time all partial/intermediate calculations have been rendered, the partial/intermediate calculations 380 may be transferred from the secondary memory 220 to the registers of another GPU 210). In specific embodiments of the system 100, the secondary memory 220 may comprise, but is not limited to, the cache of the first GPU 210-1, dedicated registers within the first GPU 210-1 or cloud storage.

As previously discussed in relation to FIG. 1, in response to identifying the first thread 352, the GPU optimization platform is further configured to execute the first thread 352 on the first GPU proximate to the actual start time 344 of the idle period 340.

In alternate embodiments of the system 100, if the first thread 352 is, or is expected to be, still executing when a second thread 354, which is awaiting execution 390 on the first GPU 210-1 after conclusion of the idle period 340, is ready for execution, GPU optimization platform is further configured to identify a second GPU 210-0 for executing the second thread 354. In response to identification of the second GPU 210-1, GPU optimization platform is further configured to execute the second thread 354 on the second GPU 210-2. In this regard, in the event that the first thread 352 is still executing on the first GPU 210-1, when the first GPU 210-1 would otherwise be ready to perform the awaiting thread (e.g., final calculation of all intermediate calculations), the awaiting thread may be moved to another GPU or, in other embodiments, the first GPU may wait on the completion of the first thread 352 before executing the second thread 354.

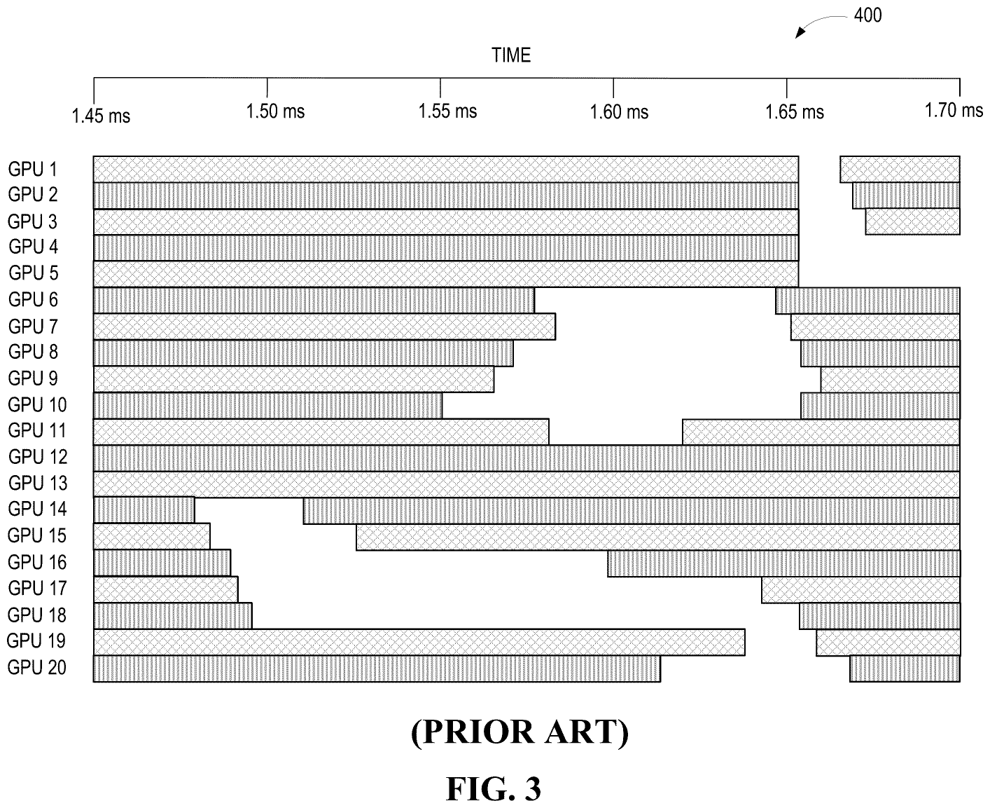

Referring to FIG. 3, a graph 400 representing processing activity for various GPUs in GPU bank (GPUs 1-21 along y-axis) across a time continuum (1.45 milliseconds to 1.70 milliseconds along the x-axis) is depicted, in accordance with the prior art. In the illustrated graph 400 of FIG. 3, the shaded areas indicated times at which the GPUs are active, i.e., executing threads for processes of jobs or the like, while the unshaded regions indicate idle periods, in which the GPUs are not actively executing threads, i.e., conducting calculations or the like. The present invention, generates data flow graph(s) for the software programs executing on the GPU bank, converts the data flow graphs to a time-scale and, based on the converted data flow graphs, estimates the upcoming idle periods (i.e., the start time of the idle periods and, in some embodiments, the end/stop time of the idle period). In response to estimating the idle periods, the invention seeks to identify threads that will be ready for execution during the idle periods. Identifying threads that will be ready for execution takes into account when the idle period opens up (i.e., the start time) and, in some embodiments, the duration of the estimated idle period (i.e., will the thread fit in the time slot).

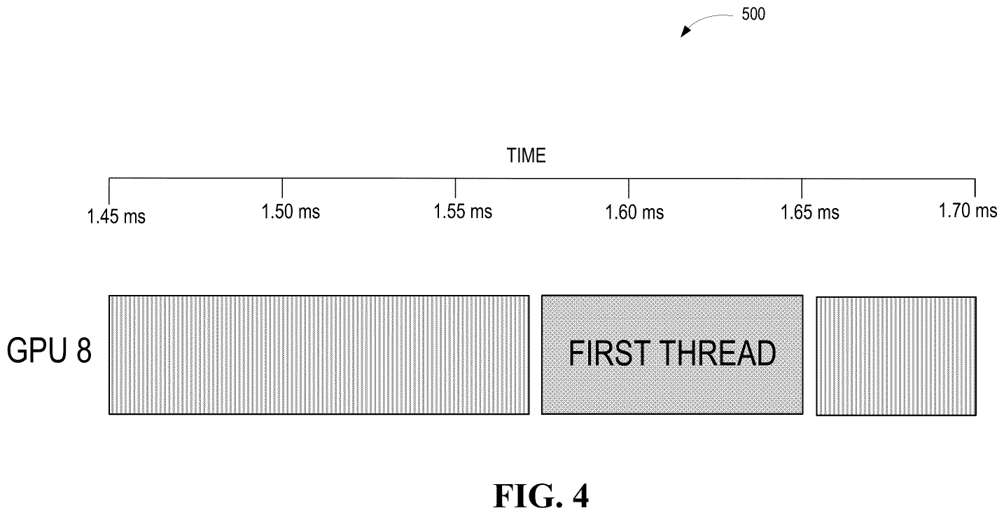

Referring to FIG. 4, a line graph 500 is depicted that illustrates a thread (i.e., first thread) being executed within an idle period experienced by one of the GPUs (i.e., GPU 8) shown in FIG. 4, in accordance with embodiments of the present invention. In the illustrated embodiments of the present invention, data flow graph(s) have been generated which serve as the basis for estimating both the start and stop times of the idle period. In response to estimating the start and stop times of the idle period, the first thread is identified, which is available for execution at the start time of the idle period (i.e., at approximately 1.57 ms) and has a duration (i.e., expected execution time) that meets the boundaries of the duration of the idle period (i.e., fits within the start time-approximately 1.57 ms and the end time-approximately 1.655 ms).

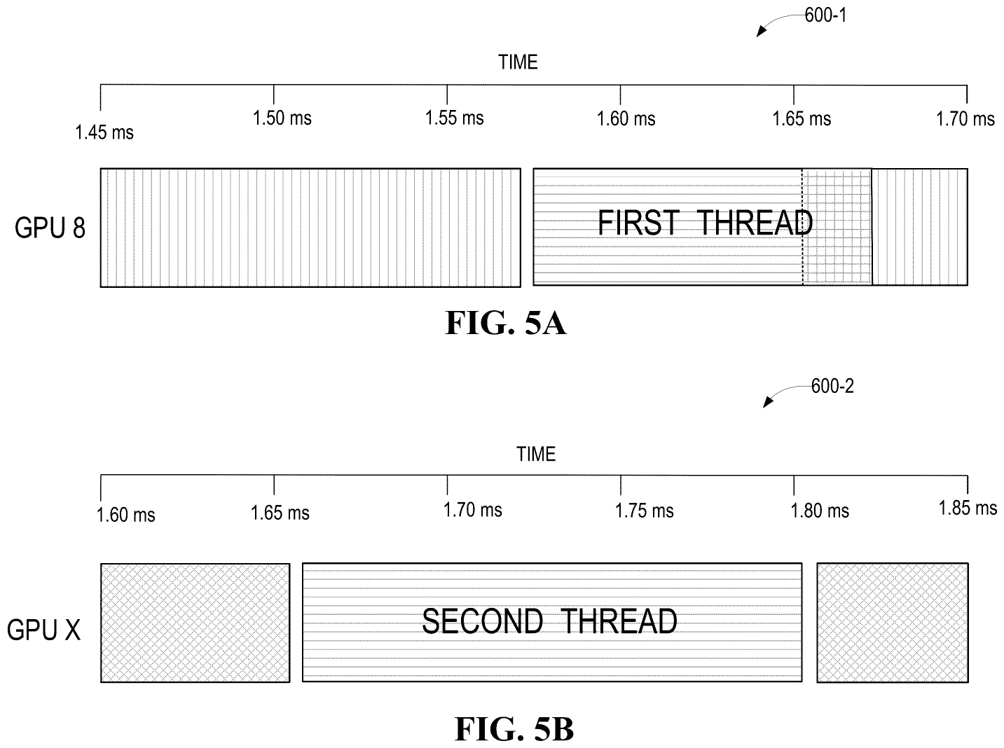

Referring to FIGS. 5A and 5B, line graphs are depicted that illustrates what may occur when a thread (i.e., first thread) exceeds or is predicted to exceed an idle period, in accordance with an embodiment of the present invention. In the illustrated embodiment shown in FIG. 5A, data flow graph(s) have been generated which serve as the basis for the start time of the idle period. In response to estimating the start time of the idle period, the first thread is identified, which is available for execution at the start time of the idle period (i.e., at approximately 1.57 ms). However, the duration of the first thread exceeds or is otherwise predicted by embodiments of the invention to exceed the duration of the idle period. For example, all of the intermediate calculations have been performed and the final calculation is ready for execution at approximately 1.65 ms but the first thread lasts until or is predicted to last until approximately 1.67 ms. In specific embodiments of the invention, the GPU, i.e., GPU 8 may wait until the first thread has completed before executing the second thread (not shown in FIG. 5). Alternatively, as shown in FIG. 5B, in response to determining that the first thread has or will exceed the duration of the idle period, another GPU (i.e., GPU X) is identified that has an available idle period proximate the end time of the idle period at GPU 8 (i.e., proximate to 1.65 ms) and subsequently the second thread is executed on the other GPU (i.e., GPU X). Such transferring of thread execution may require transfer of results of intermediate calculations from other GPUs to GPU X.

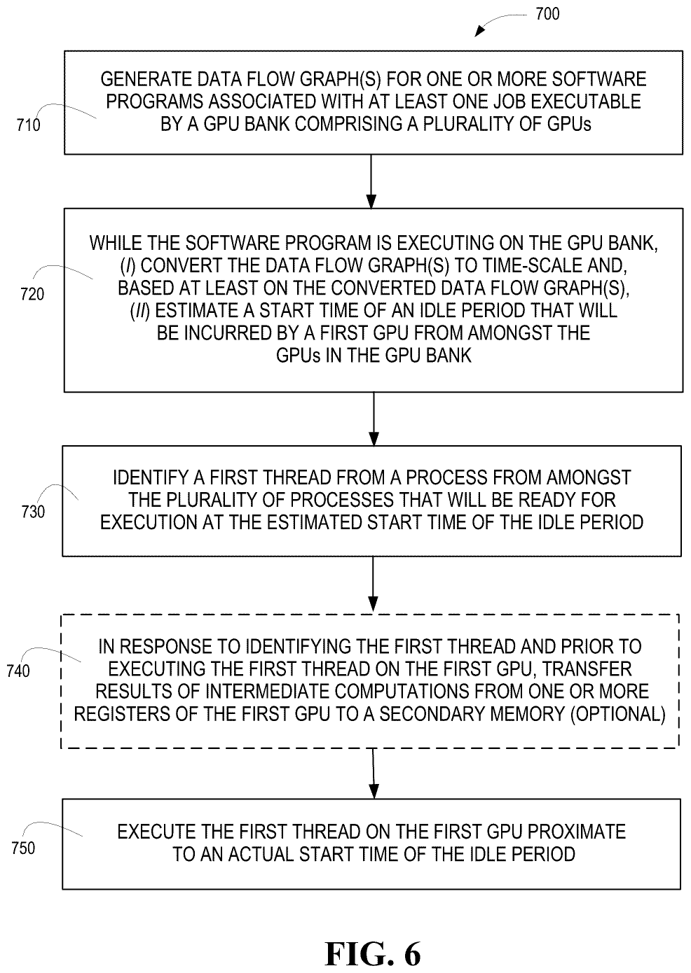

Referring to FIG. 6, a flow diagram is presented of a method 700 for optimization of GPU usage in a GPU bank, in accordance with embodiments of the present invention. At Event 710, one or more data flow graphs are generated for one or more software programs associated with at least one job being executed by a GPU bank comprising a plurality of GPUs. In specific embodiments of the invention, a data flow graph is generated for each software program/job executing on the GPU bank, while in other embodiments of the invention it may be possible to generate a consolidated data flow graph for all of the software programs executing on the GPU bank.

While the one or more software programs are executing on the GPU bank, at Event 720, (i) the data flow graph(s) are converted to time-scale and based at least on the converted data flow graph, (ii) estimating a start time of an idle period that will be incurred by a first GPU is estimated. In addition to the data flow graph(s), the start time, and in some embodiments the stop/end time, is estimated based on the number of GPUs in the GPU bank, the speed of the GPUs, the clock cycle of the GPUs, and the software programs/jobs entering and/or exiting the data flow graph(s) at any point in time.

In response to estimating the start time and, in some embodiments, the stop time of the idle period, at Event 730, a first thread of a process that will be ready for execution at the estimated start time of the idle period is identified. In specific embodiments if the method, the identification of the first thread may be based on the estimated or actual execution time of the first thread being within the time boundaries defined by the estimated start and stop times of the idle period.

In specific optional embodiments of the method, in response to identifying the first thread and prior to executing the first thread on the first GPU, at optional Event 740, results of intermediate computations processed at the first GPU are temporarily transferred from one or more registers of the first GPU to a secondary memory. Such transferring of the intermediate computations may be necessary to free up the registers for execution of the first thread. In specific embodiments of the invention, the temporary memory comprises one of (i) the cache of the first GPU, (ii) dedicated registers of the first GPU, or (iii) cloud storage. In response to identifying the first thread and, in some embodiments, transferring the results of intermediate calculations from the registers to the secondary memory, at Event 750, the first thread is executed on the first GPU proximate to an actual start time of the idle period.

Thus, as described in detail above, present embodiments of the invention include systems, methods, computer program products and/or the like for optimizing Graphics Processing Unit (GPU) efficiency within a GPU bank via idle/wait period usage. Specifically, data flow graphs are created for jobs/software programs executing on a GPU bank and the data flow graphs are utilized as the basis for estimating idle/waits periods that will be incurred by a GPU. In response to estimating the idle/wait period, a thread is identified that will be ready for execution proximate the estimated start time of the idle period and the identified thread is executed on the GPU proximate the actual start time of the idle period. Additionally, results of intermediate computations stored within the registers of the GPU may be temporarily moved to secondary storage, such as cache, dedicated registers or the like to facilitate the use of the registers for executing the identified thread during the idle/wait period.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for optimizing Graphics Processing Unit (GPU) usage, the system comprising:
a GPU bank comprising a plurality of GPUs and configured to execute a plurality of processes of one or more jobs; and
a computing platform including a memory, and one or more computing processor devices in communication with the memory, wherein the memory stores a GPU optimization platform, executable by at least one of the one or more computing processor devices and configured to:
generate one or more data flow graphs for one or more software programs associated with the one or more jobs being executed on the GPU bank;
while the one or more software programs are executing on the GPU bank, (i) convert the one or more data flow graphs to time-scale and, based at least on the converted one or more data flow graphs, (ii) estimate a start time of an idle period that will be incurred by a first GPU from amongst the plurality of GPUs in the GPU bank;
identify a first thread from a process from amongst the plurality of processes that will be ready for execution at the estimated start time of the idle period; and
execute the first thread on the first GPU proximate to an actual start time of the idle period.

2. The system of claim 1, wherein the GPU optimization platform is further configured to, in response to identifying the first thread and prior to executing the first thread on the first GPU, transfer results of intermediate computations from one or more registers of the first GPU to a secondary memory.

3. The system of claim 2, wherein the GPU optimization platform is further configured to, in response to identifying the first thread and prior to executing the first thread on the first GPU, transfer the results of intermediate computations from the one or more registers of the first GPU to a secondary memory, wherein the secondary memory is selected from a group consisting of (i) a cache of the first GPU, (ii) one or more storage registers within the first GPU dedicated for storage of the results of intermediate computations, and (iii) cloud storage.

4. The system of claim 1, wherein the GPU optimization platform is further configured to (i) convert the one or more data flow graphs to time-scale and (ii) estimate the start time of the idle period that will be incurred by the first GPU based on at least one chosen from a group consisting of (i) a volume of the plurality of GPUs, (ii) a speed of each of the plurality of GPUs, (iii) a clock cycle for each of the plurality of GPUs and (iv) jobs entering and exiting the one or more data flow graphs at a point-in-time.

5. The system of claim 1, wherein the GPU optimization platform is further configured to:
identify a second GPU from amongst the plurality of GPUs to execute a second thread which was awaiting execution on the first GPU after conclusion of the idle period; and
execute the second thread on the second GPU while the first thread is executing on the first GPU.

6. The system of claim 1, wherein the GPU optimization platform is further configured to, based at least on the converted data flow graph, estimate an end time of the idle period that will be incurred by the first GPU.

7. The system of claim 6, wherein the GPU optimization platform is further configured to identify the first thread from the process based further on an estimated execution time of the first thread being within boundaries of the start time and end time of the idle period.

8. The system of claim 1, wherein the GPU optimization platform is further configured to identify the first thread from the process, wherein the process is selected from the group consisting of (i) associated with the job undertaken by the software program, and (ii) associated with another job undertaken by a different software program.

9. A computer-implemented method for optimizing GPU usage, the computer-implemented method is executable by one or more computing processor devices, the method comprising:
generating one or more data flow graphs for one or more software programs associated with at least one job being executed by a GPU bank comprising a plurality of GPUs;
while the one or more software programs are executing on the GPU bank, (i) converting the one or more data flow graphs to time-scale and, based at least on the converted data flow graph, (ii) estimating a start time of an idle period that will be incurred by a first GPU from amongst the plurality of GPUs in the GPU bank;
identifying a first thread from a process from amongst the plurality of processes that will be ready for execution at the estimated start time of the idle period; and
executing the first thread on the first GPU proximate to an actual start time of the idle period.

10. The computer-implemented method of claim 9, further comprising:
in response to identifying the first thread and prior to executing the first thread on the first GPU, transferring results of intermediate computations from one or more registers of the first GPU to a secondary memory.

11. The computer-implemented method of claim 10, wherein transferring further comprises:
transferring the results of intermediate computations from the one or more registers of the first GPU to a secondary memory, wherein the secondary memory is selected from a group consisting of (i) a cache of the first GPU, (ii) one or more storage registers within the first GPU dedicated for storage of the results of intermediate computations, and (iii) cloud storage.

12. The computer-implemented method of claim 9, wherein converting and estimating further comprise (i) converting the one or more data flow graphs to time-scale and (ii) estimating the start time of the idle period that will be incurred by the first GPU based on at least one chosen from a group consisting of (i) a volume of the plurality of GPUs, (ii) a speed of each of the plurality of GPUs, (iii) a clock cycle for each of the plurality of GPUs, and (iv) jobs entering and exiting the one or more data flow graphs at a point-in-time.

13. The computer-implemented method of claim 9, further comprising:
identifying a second GPU from amongst the plurality of GPUs to execute a second thread which was awaiting execution on the first GPU after conclusion of the idle period; and
executing the second thread on the second GPU while the first thread is executing on the first GPU.

14. The computer-implemented method of claim 9, further comprising:
based at least on the converted data flow graph, estimating an end time of the idle period that will be incurred by the first GPU, and
wherein identifying the first thread further comprises:
identify the first thread from the process based further on an estimated execution time of the first thread being within boundaries of the start time and end time of the idle period.

15. A computer program product including a non-transitory computer-readable medium, the non-transitory computer-readable medium comprising:
a first set of codes for causing a computing device to generate one or more data flow graphs for one or more software programs associated with at least one job being executed by a GPU bank comprising a plurality of GPUs;
a second set of codes for causing a computing device to, while the one or more software programs are executing on the GPU bank, (i) convert the one or more data flow graphs to time-scale and, based at least on the converted data flow graph, (ii) estimate a start time of an idle period that will be incurred by a first GPU from amongst the plurality of GPUs in the GPU bank;
a third set of codes for causing a computing device to identify a first thread from a process from amongst the plurality of processes that will be ready for execution at the estimated start time of the idle period; and
a fourth set of codes for causing a computing device to execute the first thread on the first GPU proximate to an actual start time of the idle period web browsing session data.

16. The computer program product of claim 15, the computer-readable medium further comprises a fifth set of codes for causing a computer device to, in response to identifying the first thread and prior to executing the first thread on the first GPU, transfer results of intermediate computations from one or more registers of the first GPU to a secondary memory.

17. The computer program product of claim 16, wherein the fifth set of codes are further configured to cause the computing device to transfer the results of intermediate computations from the one or more registers of the first GPU to a secondary memory, wherein the secondary memory is selected from a group consisting of (i) a cache of the first GPU, (ii) one or more storage registers within the first GPU dedicated for storage of the results of intermediate computations, and (iii) cloud storage.

18. The computer program product of claim 15, wherein the second set of codes are further configured to cause the computing device to (i) convert the one or more data flow graphs to time-scale and (ii) estimate the start time of the idle period that will be incurred by the first GPU based on at least one chosen from a group consisting of (i) a volume of the plurality of GPUs, (ii) a speed of each of the plurality of GPUs, (iii) a clock cycle for each of the plurality of GPUs, and (iv) jobs entering and exiting the one or more data flow graphs at a point-in-time.

19. The computer program product of claim 15, wherein the computer-readable medium further comprises:
a fifth set of codes for causing a computing device to identify a second GPU from amongst the plurality of GPUs to execute a second thread which was awaiting execution on the first thread after conclusion of the idle period; and
a sixth set of codes for causing a computing device to execute the second thread on the second GPU while the first thread is executing on the first GPU.

20. The computer program product of claim 15, wherein the second set of codes are further configured to cause the computing device to, based at least on the converted data flow graph, estimate an end time of the idle period that will be incurred by the first GPU, and
wherein the third set of codes are further configured to cause the computing device to identify the first thread from the process based further on an estimated execution time of the first thread being within boundaries of the start time and end time of the idle period.
